(19) United States
(12) Patent Application Publication
(10) Pub. No.: US 2024/0224032 A1
(43) Pub. Date: Jul. 4, 2024

(54) METHOD AND APPARATUS FOR PROVIDING OR REVOKING RESOURCE OWNER'S AUTHORIZATION INFORMATION USING OAUTH

(71) Applicant: SAMSUNG ELECTRONICS CO., LTD., Suwon-si (KR)

(72) Inventors: Hongjin CHOI, Suwon-si (KR); Duckey LEE, Suwon-si (KR)

(21) Appl. No.: 18/404,792

(22) Filed: Jan. 4, 2024

(30) Foreign Application Priority Data
Jan. 4, 2023 (KR) 10-2023-0001152
Feb. 10, 2023 (KR) 10-2023-0018264
May 2, 2023 (KR) 10-2023-0057291

(51) Int. Cl. H04W 12/069; H04W 12/0431; H04W 12/082

(52) U.S. Cl. CPC H04W 12/069; H04W 12/0431; H04W 12/082

(57) ABSTRACT

The disclosure relates to 5G or 6G communication systems to support higher data rates and provide a method and apparatus for an authorization operation. The method comprises: receiving an authentication key and indicator; receiving the authentication key indicator, a first random value, or an indicator; generating a first authentication material based on the first random value and the authentication key; transmitting the generated first authentication material and a second random value; receiving a second authentication material, the second authentication material being generated by the authentication key based on the authentication key indicator and the second authentication material after verifying the first authentication material using the first random value and the authentication key; verifying the second authentication material using the authentication key; authenticating a user after verifying the second authentication material; and transmitting an authorization code, the UE redirected to the authorization function being authenticated by the API invoker.

### CROSS-REFERENCE TO RELATED APPLICATIONS

This application is based on and claims priority under 35 U.S.C. § 119 to Korean Patent Application No. 10-2023-0001152, filed on Jan. 4, 2023, Korean Patent Application No. 10-2023-0018264, filed on Feb. 10, 2023, and Korean Patent Application No. 10-2023-0057291, filed on May 2, 2023, in the Korean Intellectual Property Office, the disclosures of which are herein incorporated by reference in their entirety.

### BACKGROUND

### 1. Field

The present disclosure relates generally to a wireless communication system (or mobile communication system). Specifically, the disclosure relates to a method and apparatus for obtaining user's (or resource owner's) authorization when a specific application server attempts to access user's resources in a wireless communication system (or mobile communication system), and managing (e.g., providing or revoking) the authorization according to user's decision.

### 2. Description of Related Art

5th generation (5G) mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### SUMMARY

The disclosure is intended to provide a solution for managing user information, such as providing or revoking user's authorization information in response to a request for accessing user's resources in a mobile communication system.

In accordance with an aspect of the disclosure, a method performed by an authorization function in a wireless communication system, the method comprising: receiving, from an authentication server function (AUSF), an authentication key and an authentication key indicator; receiving, from a user equipment (UE), at least one of the authentication key indicator, a first random value, and an indicator associated with authentication; generating a first authentication material based on the first random value and the authentication key; transmitting, to the UE, the generated first authentication material and a second random value; receiving, from the UE, a second authentication material, wherein the second authentication material is generated by using the authentication key based on the authentication key indicator and the second authentication material after verifying the first authentication material using the first random value and the authentication key; verifying the second authentication material using the authentication key; authenticating a user after verifying the second authentication material; and transmitting, to an application program interface (API) invoker, an authorization code, wherein the UE redirected to the authorization function is authenticated by the API invoker.

In an embodiment of the disclosure, further comprising: receiving, from the API invoker, the authentication token request based on the authorization code; and transmitting, to the API invoker, an authentication token based on the authorization code.

In an embodiment of the disclosure, wherein the API invoker requests an API invoke including the authentication token to the API exposing function, wherein the API exposing function identify whether the authentication token is verified or revoked, and wherein, in case that the verification is successful and the authentication token is not revoked, the API exposing function transmits a response message to the API invoker.

In an embodiment of the disclosure, further comprising: transmitting, to the API invoker and the API exposing function, the authentication token and information related to the revocation of the authentication token.

In an embodiment of the disclosure, wherein the information related to the revocation of the authentication token includes at least one of a resource owner, the identifier of the token, and the token generation time.

In accordance with an aspect of the disclosure, a method performed by a user equipment (UE) in a wireless communication system, the method comprising: receiving, from an authentication server function (AUSF), an indicator associated with authentication; generating an authentication key and an authentication key indicator based on the indicator associated with the authentication; transmitting, to an authorization function, at least one of the authentication key indicator, a first random value, and the indicator associated with the authentication; receiving, from the authorization function, a first authentication material and a second random value based on the first random value and the authentication key, wherein the first authentication material is generated based on the first random value and the authentication key; verifying the first authentication material using the first random value and the authentication key; generating a second authentication material using the authentication key based on the authentication key indicator and the second random value; and transmitting, to the authorization function, the second authentication material, wherein an authorization code is transmitted from the authorization function to an API (application program interface) invoker.

In accordance with another aspect of the disclosure, an authorization function in a wireless communication system, the authorization function comprising: a transceiver; and a controller operably connected to the transceiver, wherein the controller is configured to: receive, from an authentication server function (AUSF), an authentication key and an authentication key indicator, receive, from a user equipment (UE), at least one of the authentication key indicator, a first random value, and an indicator associated with authentication, generate a first authentication material based on the first random value and the authentication key, transmit, to the UE, the generated first authentication material and a second random value, receive, from the UE, a second authentication material, wherein the second authentication material is generated by using the authentication key based on the authentication key indicator and the second authentication material after verifying the first authentication material using the first random value and the authentication key, verify the second authentication material using the authentication key, authenticate a user after verifying the second authentication material, and transmit, to an application program interface (API) invoker, an authorization code, wherein the UE redirected to the authorization function is authenticated by the API invoker.

In accordance with another aspect of the disclosure, a user equipment (UE) in a wireless communication system, the UE comprising: a transceiver; and a controller operably connected to the transceiver, wherein the controller is configured to: receive, from an authentication server function (AUSF), an indicator associated with authentication, generate an authentication key and an authentication key indicator based on the indicator associated with the authentication, transmit, to an authorization function, at least one of the authentication key indicator, a first random value, and the indicator associated with the authentication, receive, from the authorization function, a first authentication material and a second random value based on the first random value and the authentication key, wherein the first authentication material is generated based on the first random value and the authentication key, verify the first authentication material using the first random value and the authentication key, generate a second authentication material using the authentication key based on the authentication key indicator and the second random value, and transmit, to the authorization function, the second authentication material, wherein an authorization code is transmitted from the authorization function to an API (application program interface) invoker.

According to various embodiments of the disclosure, a method performed by a terminal of a mobile communication system includes receiving an SNAAPPY indication from a network during a registration process, generating S-KID and KSNAAPPY after receiving the SNAAPPY indication, transmitting an SNAAPPY indicator, when redirected to an authorization function by an API invoker, to indicate that user authentication is possible using 3GPP credentials, protecting a challenge and S-KID transmitted by the authorization function with KSNAAPPY, and verifying content protected by the authorization function with KSNAAPPY to confirm revocation of authorization information.

According to various embodiments of the disclosure, a method performed by an authorization function of a mobile communication system includes receiving KSNAAPPY, S-KID, and SUPI from an AUSF after a registration process, updating existing values to latest values when receiving latest KSNAAPPY and S-KID for same SUPI from an AUSF, performing user authentication using 3GPP credentials when receiving an SNAAPPY indicator from a UE, finding KSNAAPPY using the S-KID included in a value protected by the UE with KSNAAPPY, authenticating a user by verifying with the found KSNAAPPY, inserting the S-KID and a token creation time when generating a token, providing a revocation time to an API exposing function when receiving a token revocation request from the user, and protecting the token revocation time and a revoked token or revoked API name with KSNAAPPY and sending the request to the UE.

According to various embodiments of the disclosure, in order to prevent indiscriminate access to user-related resources in a mobile communication system, it is possible to allow a specific API invoker to invoke only APIs authorized by the user. Accordingly, it is possible to efficiently provide services optimized for the user while being safe from threats that cause harm to the user.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates CAPIF) architecture according to an embodiment of the present disclosure;

FIG. 2 illustrates a communication network including core network entities in a wireless communication system according to various embodiments of the present disclosure;

FIG. 3 illustrates a flowchart of a process for generating a key required for user authentication during an authentication process between a terminal and a network according to an embodiment of the present disclosure;

FIG. 4 illustrates a flowchart of a process for a user to provide or revoke authorization information according to an embodiment of the present disclosure;

FIG. 5 illustrates a flowchart of a process for a user to provide or revoke authorization information according to an embodiment of the present disclosure;

FIG. 6 illustrates a flowchart of a process for a user to provide authorization information according to an embodiment of the present disclosure;

FIG. 7 illustrates an example of obtaining a key used for user authentication according to an embodiment of the present disclosure;

FIG. 8 illustrates a structure of a base station according to an embodiment of the present disclosure;

FIG. 9 illustrates a structure of a terminal according to an embodiment of the present disclosure; and

FIG. 10 illustrates a structure of a network entity according to an embodiment of the present disclosure.

### DETAILED DESCRIPTION

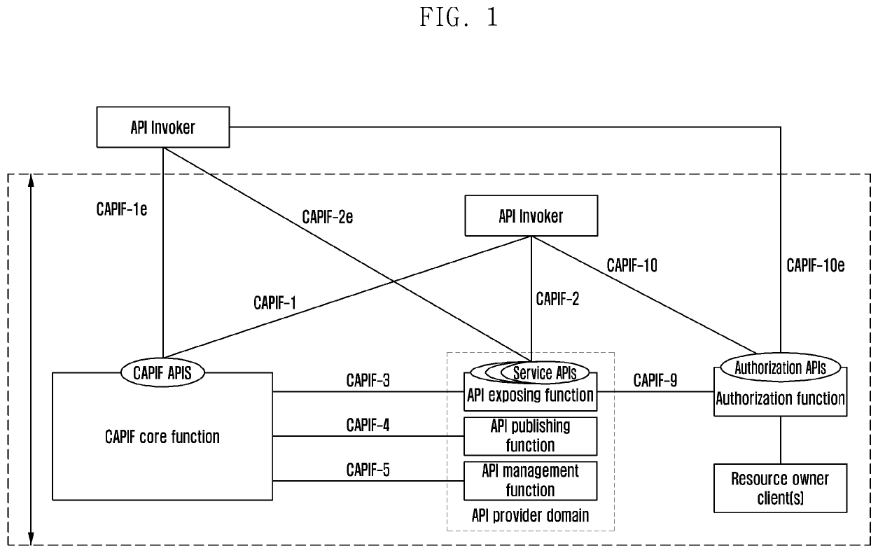

FIGS. 1 through 10, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Hereinafter, various embodiments of the disclosure will be described in detail with reference to the accompanying drawings. In describing embodiments of the disclosure, a detailed description of known functions or configurations incorporated herein will be omitted when it is determined that the description may make the subject matter of the disclosure unnecessarily unclear. Terms used herein are defined in consideration of functions in the embodiments, and may vary depending on the intention of the user or operator or custom. Therefore, the definition should be made based on the entire description herein.

For the same reason, some elements are exaggerated, omitted, or schematically illustrated in the accompanying drawings. In addition, the depicted size of each element does not completely reflect the actual size. In the drawings, the same or corresponding elements are assigned the same reference numerals.

The advantages and features of the disclosure and the manner of achieving them will become apparent through embodiments described below with reference to the accompanying drawings. The disclosure may be, however, embodied in many different forms and should not be construed as being limited to the embodiments set forth herein. Rather, these embodiments are provided so that the disclosure will be thorough and complete and will fully convey the scope of the disclosure to those skilled in the art. The disclosure is only defined by the scope of the appended claims. Throughout the specification, the same reference numerals refer to the same elements.

It will be understood that each block of the flowchart illustrations, and combinations of blocks in the flowchart illustrations, may be implemented by computer program instructions. These computer program instructions may be provided to a processor of a general purpose computer, special purpose computer, or other programmable data processing apparatus to produce a machine, such that the instructions, which are executed via the processor of the computer or other programmable data processing apparatus, generate means for implementing the functions specified in the flowchart block(s). These computer program instructions may also be stored in a computer usable or computer-readable memory that may direct a computer or other programmable data processing apparatus to function in a particular manner, such that the instructions stored in the computer usable or computer-readable memory produce an article of manufacture including instruction means that implement the function specified in the flowchart block(s). The computer program instructions may also be loaded onto a computer or other programmable data processing apparatus to cause a series of operational steps to be performed on the computer or other programmable apparatus to produce a computer implemented process such that the instructions that are executed on the computer or other programmable apparatus provide steps for implementing the functions specified in the flowchart block(s).

In addition, each block of the flowchart illustrations may represent a module, segment, or portion of code, which comprises one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used herein, the term “unit” refers to a software element or a hardware element, such as a field programmable gate array (FPGA) or an application specific integrated circuit (ASIC), which performs a predetermined function. However, the term “unit” does not always have a meaning limited to software or hardware. A “unit” may be constructed either to be stored in an addressable storage medium or to execute one or more processors. Therefore, a “unit” includes, for example, software elements, object-oriented software elements, class elements or task elements, processes, functions, properties, procedures, subroutines, segments of a program code, drivers, firmware, micro-codes, circuits, data, database, data structures, tables, arrays, and variables. The functions provided by elements and units may be combined into those of a smaller number of elements and units or separated into those of a larger number of elements and units. In addition, the elements and units may be implemented to operate one or more central processing units (CPUs) within a device or a secure multimedia card.

Embodiments of the disclosure will be described herein focusing a wireless access network, i.e., new radio (NR), and a packet core, i.e., a 5G system, a 5G core network, or a next generation (NG) core, according to the 5G mobile communication standard specified by the 3rd generation partnership project (3GPP) which is a mobile communication standardization organization. However, the subject matter of the disclosure can be also applied to other communication systems having similar technical backgrounds through slight modification without departing from the scope of the disclosure as will be apparent to those skilled in the art.

Hereinafter, terms for identifying access nodes, terms referring to network entities or network functions, terms referring to messages, terms referring to interfaces between network entities, terms referring to various types of identification information, and the like are illustratively used for the sake of convenience. Therefore, the disclosure is not limited by the terms as used below, and other terms referring to subjects having equivalent technical meanings may be used.

In the description, a base station (BS) refers to an entity that allocates resources to terminals, and may be at least one of an eNode B (eNB), a Node B (NB), a radio access network (RAN), an access network (AN), an RAN node, an NR NB, a gNode B (gNB), a wireless access unit, a BS controller, and a node on a network. A terminal may include a user equipment (UE), a mobile station (MS), a cellular phone, a smartphone, a computer, or a multimedia system capable of performing a communication function. A downlink (DL) refers to a radio transmission link via which a base station transmits a signal to a terminal, and an uplink (UL) refers to a radio transmission link via which a terminal transmits a signal to a base station. Further, in the following description, LTE or LTE-A systems may be described by way of example, but the embodiments of the disclosure may also be applied to other communication systems having similar technical backgrounds or channel types. In addition, based on determinations by those skilled in the art, the embodiments of the disclosure may also be applied to other communication systems through some modifications without significantly departing from the scope of the disclosure.

Wireless communication systems are evolving from providing a traditional voice-oriented service into wideband wireless communication systems that provide high-speed and high-quality packet data services as in communication standards such as high speed packet access (HSPA), long term evolution (LTE) (or evolved universal terrestrial radio access (E-UTRA)), or LTE-A (advanced) of 3GPP, high rate packet data (HRPD), or ultra-mobile broadband (UMB) of 3GPP2, and 802.16e of IEEE.

As a typical example of the wideband wireless communication systems, an LTE system employs an orthogonal frequency division multiplexing (OFDM) scheme in a downlink (DL) and employs a single carrier frequency division multiple access (SC-FDMA) scheme in an uplink (UL). The uplink indicates a radio link through which a user equipment (UE) transmits data or control signals to a base station (BS) (or eNB, gNB), and the downlink indicates a radio link through which the base station transmits data or control signals to the UE. The above multiple access scheme may separate data or control information of respective users by allocating and operating time-frequency resources for transmitting the data or control information for each user so as to avoid overlapping each other, that is, so as to establish orthogonality.

Since a 5G communication system, which is a communication system subsequent to LTE, may freely reflect various requirements of users, service providers, and the like, services satisfying various requirements may be supported. The services considered in the 5G communication system include enhanced Mobile Broadband (eMBB) communication, massive Machine Type Communication (mMTC), Ultra-Reliability Low-Latency Communication (URLLC), and the like.

The eMBB aims at providing a data rate higher than that supported by existing LTE, LTE-A, or LTE-Pro. For example, in the 5G communication system, the eMBB may provide a peak data rate of 20 Gbps in the downlink and a peak data rate of 10 Gbps in the uplink for a single base station. Furthermore, the 5G communication system may provide an increased user-perceived data rate to the UE, as well as the maximum data rate. In order to satisfy such requirements, transmission/reception technologies including a further enhanced Multi-Input Multi-Output (MIMO) transmission technique are required to be improved. In addition, the data rate required for the 5G communication system may be obtained using a frequency bandwidth more than 20 MHz in a frequency band of 3 to 6 GHz or 6 GHz or more, instead of transmitting signals using a transmission bandwidth up to 20 MHz in a band of 2 GHz used in LTE.

In addition, the mMTC is being considered to support application services such as the Internet of things (IOT) in the 5G communication system. The mMTC has requirements, such as support of connection of a large number of UEs in a cell, enhancement coverage of UEs, improved battery time, a reduction in the cost of a UE, and the like, in order to effectively provide the IoT. Since the IoT provides communication functions while being provided to various sensors and various devices, the IoT may support a large number of UEs (e.g., 1,000,000 UEs/km2) in a cell. In addition, the UEs supporting the mMTC may require wider coverage than those of other services provided by the 5G communication system because the UEs are likely to be located in a shadow area, such as a basement of a building, which is not covered by the cell due to the nature of the service. The UE supporting the mMTC may be configured to be inexpensive, and may require a very long battery life-time such as 10 to 15 years because it is difficult to frequently replace the battery of the UE.

Lastly, the URLLC, which is a cellular-based mission-critical wireless communication service, may be used for remote control for robots or machinery, industrial automation, unmanned aerial vehicles, remote health care, emergency alert, and the like. Thus, the URLLC may provide communication with ultra-low latency and ultra-high reliability. For example, a service supporting the URLLC may satisfy an air interface latency of less than 0.5 ms, and also requires a packet error rate of 10-5 or less. Therefore, for the services supporting the URLLC, a 5G system may provide a transmit time interval (TTI) shorter than those of other services, and also may require a design for assigning a large number of resources in a frequency band in order to secure reliability of a communication link.

Three services in 5G, that is, eMBB, URLLC, and mMTC, may be multiplexed and transmitted in a single system. In this case, different transmission/reception techniques and transmission/reception parameters may be used between services in order to satisfy different requirements of the respective services. Of course, 5G is not limited to the three services described above.

In the description, LTE, LTE-A, LTE Pro, 5G (or NR), or 6G systems will be described by way of example, but the embodiments of the disclosure may also be applied to other communication systems having similar technical backgrounds or channel types. In addition, based on determinations by those skilled in the art, the embodiments of the disclosure may also be applied to other communication systems through some modifications without significantly departing from the scope of the disclosure.

As described above, with the development of mobile communication systems, various services can be provided to terminals. In order to provide optimal services to UE depending on the location or status of the UE, an application programming interface (API) invoker (e.g., application server) needs to access UE's resources. However, such access by the API invokers to the UE's resources without user's authorization may be strictly handled because the access can cause unexpected damage to the user (for example, receiving the location information of the terminal may lead to a violation of the user's privacy, and requesting the 3GPP system to change the quality of service (QOS) for the application traffic may result in unexpected charges to the user). Therefore, methods are needed to allow the API invokers authorized by the user to access the authorized UE resources only as long as the user wants, and to disallow the API invokers not authorized by the user to access the UE resources that may pose a risk of harm to the user.

In order to prevent unauthorized API invokers from requesting UE resources from the 3GPP system without the user's authorization, a method is needed for the user to authorize the application to use the UE resources and for the 3GPP system to determine whether the true user has authorized this. In addition, there is a need for a method that allows the user to manage authorization for the API invoker's access to the UE resources as desired, such as revoking already authorized content based on the user's decision later.

Additionally, in mobile communication systems, there is a need for methods to check whether the API invoker requesting the UE resources has received the user's authorization. Also, there is a need for a method to check whether the real user of the UE has granted authorization for the API invoker's authorization request.

According to various embodiments of the disclosure, during the authentication process, authentication server function (AUSF) may receive a SNAAPPY indication from unified data management (UDM). This indication indicates to the user equipment (UE) and AUSF to create an S-KID and KSNAAPPY, and may indicate that user authentication can be performed using KSNAAPPY obtained from 3GPP credentials rather than ID/PW during the OAuth 2.0 process.

The user may select, through an application installed in the UE, whether to allow the application to access the UE resources. This method may adopt the widely used OAuth 2.0, and for user authentication, the API invoker can redirect the UE to authorization function. When the UE is redirected to the authorization function, an SNAAPPY indicator may be provided to indicate that the UE has KSNAAPPY and the user can be authenticated with the 3GPP credentials. If the authorization function that has received the SNAAPPY indicator decides to authenticate the user with the 3GPP credentials rather than ID/PW, a challenge value may be transmitted to the UE. The UE may perform authentication by protecting the challenge value and S-KID with KSNAAPPY and providing them to the authorization function. At this time, methods such as encryption, forgery and tampering protection, or electronic signatures may be used through an encryption key agreed upon or shared with the mobile communication system in advance. After user authentication, if there is an API authorized by the user for the API invoker, the authorization function can create an OAuth 2.0 token based on this.

The authorization function can issue, to the API invoker, a token including at least one of API invoker information (e.g., API invoker's ID) for identifying the API invoker, the name of the service API that the API invoker can invoke in the 3GPP system, information on the API exposing function that can invoke the API, an S-KID that is an ID related to a key that can receive the UE ID for identifying the UE in the 3GPP system, information such as an authorization validity period and a token creation time, and the address of the authorization function. At this time, to prevent the API invoker from forging or tampering the token issued by the authorization function, the token may be subject to processing such as encryption, forgery and tampering protection, or electronic signature using the private key of the authorization function through an encryption key agreed upon or shared with the mobile communication system in advance.

The API invoker that has received the token makes a request to access the UE resources, including the received token, to the API exposing function. The mobile communication system that has received this request can use the token included in the API invoker's request to confirm whether the request is permitted for the API invoker to access the UE resources. If the request is confirmed to be a legitimate request with the user's authorization, the API exposing function can provide the API invoker with a response to the request to access the UE resources. If the token included in the request for access to the UE resources is an incorrect token, if the token usage time has elapsed, or if the token usage time has not elapsed, but the token is requested to be revoked by the user, the API exposing function may deny access to the UE resources requested by the API invoker.

If the user requests token revocation through the application, the API invoker can make a token revocation request to the authorization function as specified in RFC 7009. The authorization function that has receives the revocation request can notify, to the API exposing function, a token revocation time and the revoked token or related information (e.g., API invoker ID and revoked API information). The API exposing function can reject the request if the API invoker invokes the revoked API by presenting a token generated before the token revocation time even though the token usage time has not elapsed. The authorization function can protect the token revocation time and the revoked token or related information (e.g., API invoker ID and revoked API information) with KSNAAPPY and transmit them to the UE through the API invoker. The UE that has received this may verify this and confirm that the revocation-requested token has been revoked.

The unit that performs each function provided by the 5G network system can be defined as a network function (NF) (or network entity). An example of the structure of a 5G mobile communication network is shown in FIG. 1.

FIG. 1 illustrates a common application program interface (API) framework (CAPIF) architecture according to an embodiment of the present disclosure.

As shown in FIG. 1, network entities in the API Provider domain interact with a CAPIF core function. The CAPIF core function in the public land mobile network (PLMN) trust domain supports service APIs. As shown in FIG. 1, API invokers may exist inside the PLMN trust domain, inside the 3rd party trust domain, or outside the PLMN trust domain and the 3rd party trust domain.

The API invoker within the PLMN trust domain interacts with the CAPIF core function through CAPIF-1, calls service APIs within the PLMN trust domain through CAPIF-2, and calls service APIs of the third-party trust domain through CAPIF-2e. The API invoker within the third-party trust domain interacts with the CAPIF core function through CAPIF-1e, calls the service APIs of the PLMN trust domain through CAPIF-2e, and calls the service APIs of the third-party trust domain through CAPIF-2.

The API invoker outside the PLMN trust domain and the third-party trust domain interacts with the CAPIF core function through CAPIF-1e and calls the service APIs within the third-party trust domain and the service APIs within the PLMN trust domain through CAPIF-2e.

In an embodiment, an API exposing function (e.g., it may be a network exposure function (NEF) or an NF capable of providing an API), an API publishing function, and an API management function within the PLMN trust domain interact with the CAPIF core function through CAPIF-3, CAPIF-4, and CAPIF-5, respectively.

The CAPIF-3 and CAPIF-4 interfaces allow the service APIs to interact with the CAPIF core function through the API publishing function. The CAPIF-3 and CAPIF-4 interfaces can support the following features.
1. Service API information can be published to the API registry so that applications can discover the service APIs.
2. Application authentication can be confirmed when the service API is invoked.
3. Authorization to access the service API can be received from the CAPIF core function.
4. API lifecycle management, for example, starting or stopping the service API, can be notified to the CAPIF core function.
5. API events, for example, changes in the location of the application calling the service API or faults in the service API, can be reported to the CAPIF core function.
6. API monitoring events, such as load and resource usage, can be reported to the CAPIF core function.
7. Service API calling events can be logged in CAFF, for example, caller ID, IP address, service API name, version, input parameters, call result, and timestamp.
8. Billing records generated from service API calls can be reported to the CAPIF core function.
9. In service APIs, the API provider can enforce the configured policies.

The interaction between the API management function and the CAPIF core function is expressed by the CAPIF-5 interface.

The CAPIF-5 interface allows the API provider to interact with the CAPIF core function for the API management function. The CAPIF-5 interface supports the following functions.
1. The API provider can set policies, for example, API call limits or blocking API calls for a certain period of time, regardless of whether the API calls are allowed while roaming.
2. An access control list of service APIs can be set for each application.
3. Service API call event logs can be accessed and a log storage period can be set.
4. The CAPIF core function can request approval for new application registration and can confirm successful registration.
5. The API provider can update application profile information stored in database.
6. The API provider can manage the lifecycle state of the service API.
7. The API provider can notify service API events such as service API faults, application call API location changes, FHEM, resource usage, and billing records.

The API exposing function communicates with the CAPIF core function to perform at least one of access control, data logging, billing, authentication, and authorization of the service APIs through the CAPIF-3 interface.

The API publishing function publishes at least one service API to the CAPIF core function in the PLMN domain through CAPIF-4. The API publishing function is a logical entity that supports the service APIs to interact with the CAPIF core function and, in some cases, receives service API-related management commands from the API management function. The logical entity is also called a framework control agent or a framework control function, and can be physically disposed as the service APIs or a standalone entity.

The API management function communicates with the CAPIF core function in the PLMN domain and performs at least one of access monitoring, policy configuration, and provisioning of API caller clients through CAPIF-5. Additionally, the API management function allows the API provider to read and write API management information to and from the CAPIF core function, and allows the API provider to provide management commands to the service APIs through the API publishing function.

Communication between the API exposing function and the CAPIF core function, communication between the API publishing function and the CAPIF core function, and communication between the API management function and the CAPIF core function may be API-based communication through CAPIF-3, CAPIF-4, and CAPIF-5, respectively.

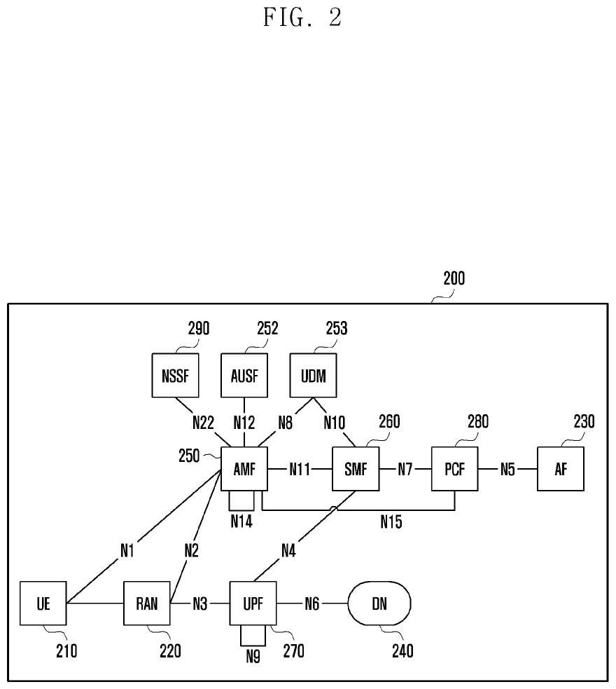

FIG. 2 illustrates a communication network including core network entities in a wireless communication system according to various embodiments of the present disclosure.

With reference to FIG. 2, a user equipment (UE) 210 may perform communication through a wireless channel established with a base station (e.g., eNB, gNB), that is, an access network. In some embodiments, the UE 210 is a device used by a user and may be a device configured to provide a user interface (UI). As an example, the UE 210 may be a terminal equipped in a vehicle for driving. In some other embodiments, the UE 210 may be a device that performs machine type communication (MTC) without user involvement, or may be an autonomous vehicle. The UE may be referred to as, in addition to an electronic device, “a terminal,” “a vehicle terminal,” “a mobile station,” “a subscriber station,” “a remote terminal,” “a wireless terminal,” “a user device,” or any other term having equivalent technical meaning. As a terminal, in addition to the UE, customer-premises equipment (CPE) or a dongle type terminal may be used. The CPE can provide a network to other communication equipment (e.g., laptop) while being connected, like the UE, to an NG-RAN node.

With reference to FIG. 2, an AMF 250 provides a function of access and mobility management for each UE 210, and basically each UE 210 can be connected to one AMF 250. Specifically, the AMF 250 can perform at least one function of signaling between core network nodes for mobility between 3GPP access networks, an interface (N2 interface) with a radio access network (e.g., 5G RAN) 220, NAS signaling with the UE 210, identification of an SMF 260, and delivery of a session management (SM) message between the UE 210 and the SMF 260. Some or all of the functions of the AMF 250 may be supported within a single instance of the AMF 250.

With reference to FIG. 2, the SMF 260 provides a session management function, and when the UE 210 has multiple sessions, such sessions may each be managed by different SMFs 260. Specifically, the SMF 260 may perform at least one function of session management (e.g., establishing, modifying, and releasing sessions, including maintaining a tunnel between a UPF 270 and an access network node), selection and control of a user plane (UP) function, setup of traffic steering to route traffic to an appropriate destination in the UPF 270, termination of an SM portion of NAS message, downlink data notification (DDN), and an initiator of AN-specific SM information (e.g., delivery to the access network through N2 interface via the AMF 250). Some or all of the functions of the SMF 260 may be supported within a single instance of the SMF 260.

In the 3GPP system, conceptual links connecting the NFs in the 5G system may be referred to as reference points. The reference point may also be referred to as an interface. The following shows some examples of reference points (hereinafter used interchangeably with interfaces) included in the 5G system architecture expressed across various embodiments of the disclosure:
N1: Reference point between UE 210 and AMF 250;
N2: Reference point between (R)AN 220 and AMF 250;
N3: Reference point between (R)AN 220 and UPF 270;
N4: Reference point between SMF 260 and UPF 270;
N5: Reference point between PCF 280 and AF 230;
N6: Reference point between UPF 270 and DN 240;
N7: Reference point between SMF 260 and PCF 280;
N8: Reference point between UDM 253 and AMF 250;
N9: Reference point between two core UPFs 270;
N10: Reference point between UDM 253 and SMF 260;
N11: Reference point between AMF 250 and SMF 260;
N12: Reference point between AMF 250 and authentication server function (AUSF) 251;
N13: Reference point between UDM 253 and AUSF 251;
N14: Reference point between two AMFs 250; and
N15: Reference point between PCF 280 and AMF 250 for non-roaming scenarios, or reference point between PCF 280 and AMF 250 in visited network for roaming scenarios.

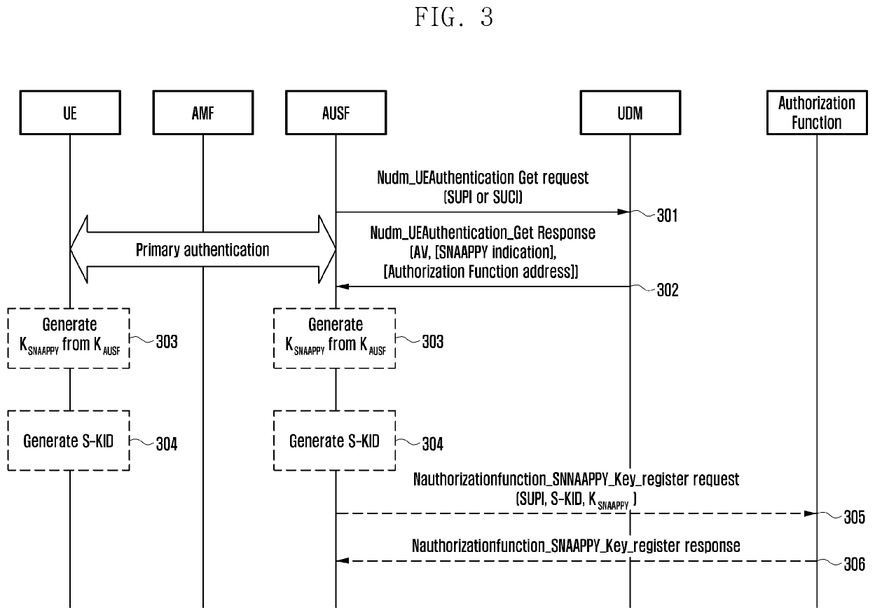

FIG. 3 illustrates a flowchart of a process for generating SNAAPPY-related materials while a UE accesses a network and performs authentication.

With reference to FIG. 3, while the UE performs a primary authentication process with the network, steps 301 and 302 may be performed in the network.

In step 301, the AUSF can perform an authentication request by providing subscription permanent identifier (SUPI) or subscription concealed identifier (SUCI) to the UDM.

In step 302, the UDM can find the long term credential (K) for the corresponding SUPI and generate an authentication vector (AV). If the operator network supports user authentication using 3GPP credentials, the SNAAPPY indication or the address for the authorization function can also be sent. The AUSF that has received this can transmit the SNAAPPY indication or the address for the authorization function to the UE during the authentication process.

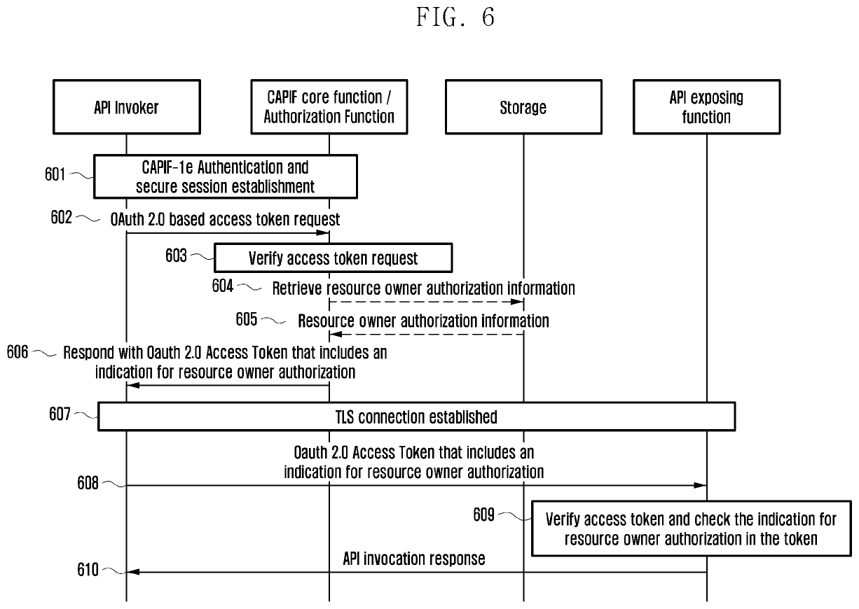

In step 303, during the authentication process, the UE and the AUSF that have received the SNAAPPY indication can generate KSNAAPPY. When generating KSNAAPPY, it is possible to use strings such as “authorization” or “SNAAPPY” and materials such as KAUSF as input. The KSNAAPPY generation will be described in detail later in FIG. 6.

In step 304, the UE and the AUSF can generate a SNAAPPY Key Identifier (S-KID) representing KSNAAPPY. The S-KID may be in the format of Network Access Identifier (NAI) (i.e., username@realm). The username part of the S-KID may include SNAAPPY Temporary Identifier (S-TID), and the S-TID can be generated by using materials such as SUPI and KAUSF as input so as to be used as a temporary ID for the UE. The realm part of the S-KID may include at least one of an ID indicating UE's home network or an address of the authorization function.

In step 305, the AUSF can request registration of SUPI with the generated S-KID and KSNAAPPY to the authorization function. When the AUSF searches for the authorization function, AUSF can also use address information for the authorization function received from the UDM in step 302.

In step 306, the authorization function can send an SNAPPY Key registration response to the AUSF. The authorization function can check whether there is a previously stored S-KID and KSNAAPPY for the SUPI received from the AUSF in step 305. If there is previously saved information, the information can be updated with the S-KID and KSNAAPPY newly received in step 305.

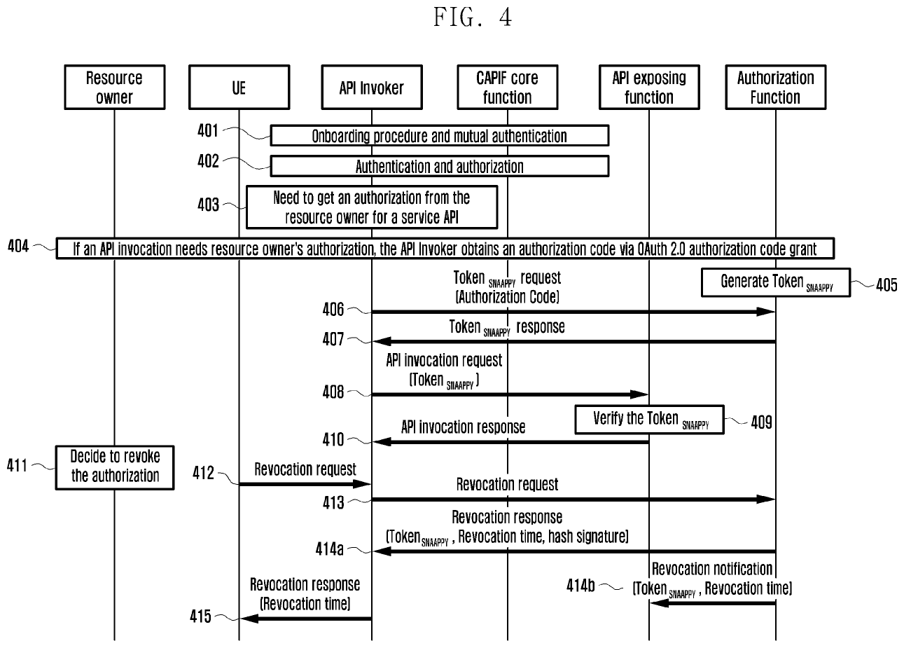

FIG. 4 illustrates a flowchart of a process for a user to provide or revoke authorization information according to an embodiment of the present disclosure.

For the procedure shown in FIG. 4, the process of FIG. 3 may be performed in advance.

With reference to FIG. 4, in step 401, the API invoker can perform an onboarding process with the CAPIF core function and then perform a mutual authentication process with the CAPIF core function.

In step 402, the API invoker can perform the API exposing function and authentication process and know the API information permitted to invoke the API exposing function through this process. The method may be that the CAPIF core function issues an OAuth token to the API invoker, or that the CAPIF core function provides related information to the API invoker and provides the information together when the API invoker invokes the API.

In step 403, the API invoker can know that user's authorization information is required to invoke a specific API. In this regard, the content of a document received when the application service provider signs a contract with the API domain provider may include the content that user's authorization information is required to invoke a specific API (e.g., the content that TokenSNAAPPY is required to invoke a specific API), and when receiving authorization information from the CAPIF core function or the API exposing function in step 402, an indicator that a specific API requires user's authorization may be received.

In step 404, the API invoker can obtain an authorization code using the Oauth 2.0 authorization code grant model. If the UE receives a SNAAPPY indication from the network in the pre-setup process (FIG. 3) and generates S-KID and KSNAAPPY, the UE can provide the authorization function with at least one of S-KID, challenge_UE generated by the UE, and SNAAPPY indicator while redirected to the authorization function by the API invoker. The API invoker can transmit the scope (e.g., modify QoS, location, etc.) requested by the API invoker together while redirecting the UE to the authorization function. The SNAAPPY indicator may indicate that the user of the corresponding UE can be authenticated using KSNAAPPY generated from 3GPP credentials rather than ID/PW. If the authorization function that has received the SNAAPPY indicator decides to authenticate the user of the corresponding UE using KSNAAPPY rather than ID/PW, the authorization function may transmit a response requesting authentication to the UE. This response may include authentication material that protects challenge_UE using KSNAAPPY (e.g., MAC calculation of challenge_UE using KSNAAPPY found using S-KID), and challenge_AF which is a random value generated by the authorization function. The UE that has receives the response can verify the authentication material sent by the authorization function using KSNAAPPY and challenge_UE, and then can generate authentication material (e.g., MAC calculation using KSNAAPPY) using at least one of S-KID and challenge_AF as input and using KSNAAPPY. The UE can send the generated authentication material to the authorization function. The authorization function can find KSNAAPPY based on S-KID, and can use KSNAAPPY to authenticate the user after verifying the authentication material sent by the UE. Alternatively, when the UE and the authorization function perform authentication, mutual authentication may be performed using a shared key. After authentication is completed, a list of what the user can authorize (the scope requested by the API invoker) and information related to the API invoker (the name or ID of the API invoker) may be displayed through the UE. After the user selects the API information to be authorized to the API invoker, the authorization function can send the authorization code to the API invoker. Additionally, depending on the operator's policy, a process to authenticate the actual user may be added in addition to the authentication presented above.

In step 405, the authorization function can generate TokenSNAAPPY which is an Oauth token. The token may include at least one of information (e.g., the API invoker's ID) about the API invoker that can identify the API invoker, the name of the service API that the API invoker can invoke in the API exposing function, information on the API exposing function that can invoke the API, S-KID which is an ID related to a key for receiving the UE ID that can identify the UE in the 3GPP system, generic public subscription identifier (GPSI) which is the UE's external ID, the authorization validity period, a unique value that can distinguish a token (e.g., information such as a token creation time or a combination of at least one of UE ID, API invoker ID, allowed API, and random number), and the address of the authorization function.

In step 406, the API invoker can make a TokenSNAAPPY request to the authorization function by presenting the authorization code received in Step 404.

In step 407, the authorization function can check the authorization code received in step 406 and then provide the corresponding Oauth token, TokenSNAAPPY, to the API invoker.

In step 408, the API invoker can make an API invocation request to the API exposing function. This request may include TokenSNAAPPY received from the authorization function in step 407.

In step 409, the API exposing function can check whether the API invoker can invoke the corresponding API, through the process in step 402. The API exposing function can check whether the service API invoked by the API invoker in step 408 is an API that requires user's authorization. If the API invoker does not present the corresponding TokenSNAAPPY even though a service API requires user's authorization, the request can be rejected. If the API invoker requests a service API that requires user's authorization by presenting TokenSNAAPPY, TokenSNAAPPY can be verified. If the verification of TokenSNAAPPY is successful, the API exposing function can check at least one of whether the API requested by the API invoker belongs to the “service API name that the API invoker of the token can invoke in the API exposing function,” whether the current time is within the token's “authorization validity period,” and whether the creation time of the token is later than the revocation time if the revocation time is received along with the revocation request for the token. If the revocation time is received along with a request for revocation of the token, and the creation time of the token is earlier than the revocation time, the request may be rejected even if the token's authorization is valid in time.

In step 410, if the verification of TokenSNAAPPY is successful and the contents of the token all match, the API exposing function can make an API invocation response. The API exposing function can check whether the token has been revoked through the revocation information stored before verifying the token, and the API exposing function can also check the revocation information after successfully verifying the token.

In step 411, the user can decide to revoke the token at any time, even before the authorization validity period expires.

In step 412, the user can make a token revocation request to the API invoker through the UE. An application developer can also develop UI related to token revocation when developing an application.

In step 413, the API invoker can request the authorization function to revoke the token requested by the user in accordance with a scheme specified in RFC 7009. This scheme may use a method that the API invoker makes token revocation request to the authorization function by using the application/x-www-form-urlencoded format.

In step 414, in order for the user to know that the token requested by the user has been properly revoked, the authorization function can deliver the API information that is no longer authorized for the revoked token or the corresponding API invoker, and the revocation time to the UE through the API invoker by using KSNAAPPY (e.g., calculating message authentication code (MAC)). In addition, the authorization function may transmit the token revocation time and the revoked token to the API exposing function. Alternatively, when transmitting revocation information to the API exposing function, the authorization function may transmit value(s) that can identify the corresponding token without transmitting the revoked token itself, or may also transmit the API invoker's ID, the API information that the API invoker can no longer invoke, the ID related to the corresponding UE, the revocation time, or a value that can distinguish the revoked token. If the API exposing function has received the token revocation time and the revoked token, the API exposing function can reject the request if the API invoker invokes the API by using TokenSNAAPPY generated before the revocation time. Alternatively, if the API exposing function has received a value (e.g., the token itself, or a value that distinguishes that token from other tokens) that can distinguish the token along with the token validity period when the revocation notification is received, the API exposing function can reject the request if the API invoker invokes the API by using the token containing that value. The API exposing function may store the TokenSNAAPPY requested to be revoked or the value(s) that can distinguish the token, up to the token validity period. The API exposing function can delete the value(s) associated with the revoked token after the validity period has expired. If an API invoker invokes an API using a token whose validity period has expired, the API exposing function can determine the validity of the token using only the token validity period. Therefore, if the token validity period has expired, the API exposing function can also delete the token's revocation information (this could be the token itself, a value that identifies the token, or its validity period).

In step 415, the API invoker can verify the transmitted information by using the revoked token received from the authorization function in step 414 or the API information no longer authorized for the API invoker, the revocation time, and KSNAAPPY stored by the UE. If verification fails, the user may notice that the API invoker does not properly deliver the user's request to the authorization function and may continue to use the token.

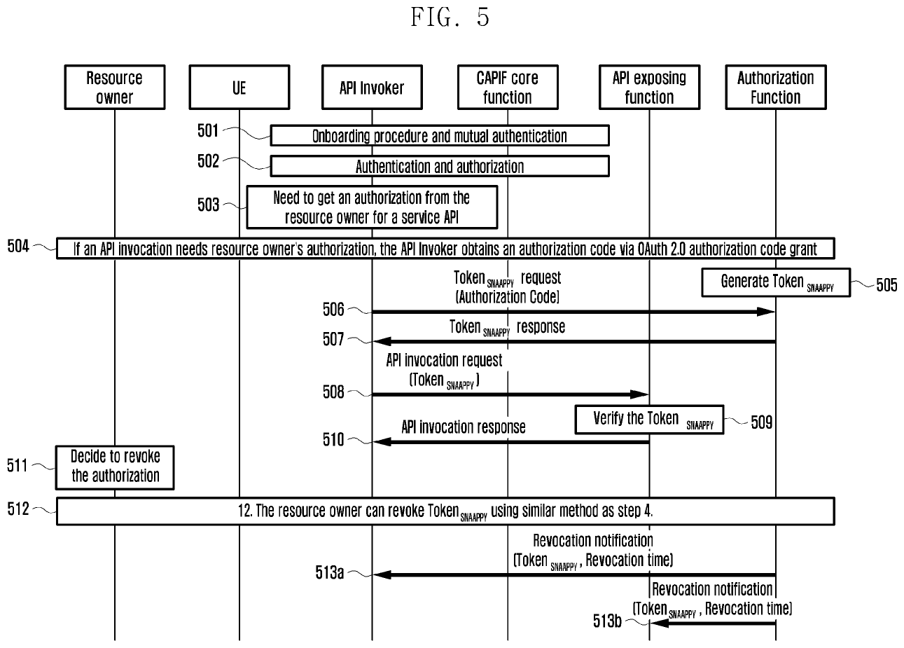

FIG. 5 illustrates a flowchart of a process for a user to provide or revoke authorization information according to an embodiment of the present disclosure.

For the procedure shown in FIG. 5, the process of FIG. 3 may be performed in advance.

With reference to FIG. 5, in step 501, the API invoker can perform an onboarding process with the CAPIF core function and then perform a mutual authentication process with the CAPIF core function.

In step 502, the API invoker can perform the API exposing function and authentication process and know the API information permitted to invoke the API exposing function through this process. The method may be that the CAPIF core function issues an OAuth token to the API invoker, or that the CAPIF core function provides related information to the API invoker and provides the information together when the API invoker invokes the API.

In step 503, the API invoker can know that user's authorization information is required to invoke a specific API. In this regard, the content of a document received when the application service provider signs a contract with the API domain provider may include the content that user's authorization information is required to invoke a specific API (e.g., the content that TokenSNAAPPY is required to invoke a specific API), and when receiving authorization information from the CAPIF core function or the API exposing function in step 502, an indicator that a specific API requires user's authorization may be received.

In step 504, the API invoker can obtain an authorization code using the OAuth 2.0 authorization code grant model. If the UE receives a SNAAPPY indication from the network in the pre-setup process (FIG. 3) and generates S-KID and KSNAAPPY, the UE can provide the authorization function with at least one of S-KID, challenge_UE generated by the UE, and SNAAPPY indicator while redirected to the authorization function by the API invoker. The API invoker can transmit the scope (e.g., modify QoS, location, etc.) requested by the API invoker together while redirecting the UE to the authorization function. The SNAAPPY indicator may indicate that the user of the corresponding UE can be authenticated using KSNAAPPY generated from 3GPP credentials rather than ID/PW. If the authorization function that has received the SNAAPPY indicator decides to authenticate the user of the corresponding UE using KSNAAPPY rather than ID/PW, the authorization function may transmit a response requesting authentication to the UE. This response may include authentication material that protects challenge_UE using KSNAAPPY (e.g., MAC calculation of challenge_UE using KSNAAPPY found using S-KID), and challenge_AF which is a random value generated by the authorization function. The UE that has receives the response can verify the authentication material sent by the authorization function using KSNAAPPY and challenge_UE, and then can generate authentication material (e.g., MAC calculation using KSNAAPPY) using at least one of S-KID and challenge_AF as input and using KSNAAPPY. The UE can send the generated authentication material to the authorization function. The authorization function can find KSNAAPPY based on S-KID, and can use KSNAAPPY to authenticate the user after verifying the authentication material sent by the UE. If the authorization function does not receive the SNAAPPY indicator, any method other than the authentication method using KSNAAPPY can be used. After authentication is completed, a list of what the user can authorize (the scope requested by the API invoker) and information related to the API invoker (the name or ID of the API invoker) may be displayed through the UE. After the user selects the API information to be authorized to the API invoker, the authorization function can send the authorization code to the API invoker. Additionally, depending on the operator's policy, a process to authenticate the actual user may be added in addition to the authentication presented above.

In step 505, the authorization function can generate TokenSNAAPPY which is an OAuth token. The token may include at least one of information (e.g., the API invoker's ID) about the API invoker that can identify the API invoker, the name of the service API that the API invoker can invoke in the API exposing function, information on the API exposing function that can invoke the API, S-KID which is an ID related to a key for receiving the UE ID that can identify the UE in the 3GPP system, Generic Public Subscription Identifier (GPSI) which is the UE's external ID, the authorization validity period, a token creation time, and the address of the authorization function.

In step 506, the API invoker can make a TokenSNAAPPY request to the authorization function by presenting the authorization code received in Step 504.

In step 507, the authorization function can check the authorization code received in step 506 and then provide the corresponding OAuth token, TokenSNAAPPY, to the API invoker.

In step 508, the API invoker can make an API invocation request to the API exposing function. This request may include TokenSNAAPPY received from the authorization function in step 507.

In step 509, the API exposing function can check whether the API invoker can invoke the corresponding API, through the process in step 502. The API exposing function can check whether the service API invoked by the API invoker in step 508 is an API that requires user's authorization. If the API invoker does not present the corresponding TokenSNAAPPY even though a service API requires user's authorization, the request can be rejected. If the API invoker requests a service API that requires user's authorization by presenting TokenSNAAPPY, TokenSNAAPPY can be verified. If the verification of TokenSNAAPPY is successful, the API exposing function can check at least one of whether the API requested by the API invoker belongs to the “service API name that the API invoker of the token can invoke in the API exposing function,” whether the current time is within the token's “authorization validity period,” and whether the creation time of the token is later than the revocation time if the revocation time is received along with the revocation request for the token. If the revocation time is received along with a request for revocation of the token, and the creation time of the token is earlier than the revocation time, the request may be rejected even if the token's authorization is valid in time.

In step 510, if the verification of TokenSNAAPPY is successful and the contents of the token all match, the API exposing function can make an API invocation response. The API exposing function can check whether the token has been revoked through the revocation information stored before verifying the token, and the API exposing function can also check the revocation information after successfully verifying the token.

In step 511, the user can decide to revoke the token at any time, even before the authorization validity period expires.

In step 512, the user can revoke TokenSNAAPPY using a method similar to step 504. First, if the user makes a token revocation request to the API invoker through the UE, the API invoker can redirect the UE to the authorization function. If the UE receives a SNAAPPY indication in the pre-setup process (FIG. 3) and generates S-KID and KSNAAPPY, the UE can provide the authorization function with at least one of S-KID, challenge_UE generated by the UE, and SNAAPPY indicator while redirected to the authorization function by the API invoker. The API invoker can also transmit API information (e.g., modify QoS, location, etc.) that the user wants to revoke while redirecting the UE to the authorization function. The SNAAPPY indicator may indicate that the user of the corresponding UE can be authenticated using KSNAAPPY generated from 3GPP credentials rather than ID/PW. If the authorization function that has received the SNAAPPY indicator decides to authenticate the user of the corresponding UE using KSNAAPPY rather than ID/PW, the authorization function may transmit a response requesting authentication to the UE. This response may include authentication material that protects challenge_UE using KSNAAPPY (e.g., MAC calculation of challenge_UE using KSNAAPPY found using S-KID), and challenge_AF which is a random value generated by the authorization function. The UE that has receives the response can verify the authentication material sent by the authorization function using KSNAAPPY and challenge_UE, and then can generate authentication material (e.g., MAC calculation using KSNAAPPY) using at least one of S-KID and challenge_AF as input and using KSNAAPPY. The UE can send the generated authentication material to the authorization function. The authorization function can find KSNAAPPY based on S-KID, and can use KSNAAPPY to authenticate the user after verifying the authentication material sent by the UE. If the authorization function does not receive the SNAAPPY indicator, any method other than the authentication method using KSNAAPPY can be used. After authentication is completed, the authorization function can display a list that the user can revoke and information related to the API invoker (the name or ID of the API invoker) through the UE. After the user selects the API information that may no longer be authorized to the API invoker, the authorization function can revoke TokenSNAAPPY. Additionally, depending on the operator's policy, a process to authenticate the actual user may be added in addition to the authentication presented above.

In step 513, the authorization function can transmit TokenSNAAPPY and the token revocation time to the API invoker and the API exposing function. Alternatively, when transmitting revocation information to the API exposing function, the authorization function may transmit value(s) that can identify the corresponding token without transmitting the revoked token itself, or may also transmit the API invoker's ID, the API information that the API invoker can no longer invoke, the ID related to the corresponding UE, the revocation time, or a value that can distinguish the revoked token. If the API exposing function has received the token revocation time and the revoked token, the API exposing function can reject the request if the API invoker invokes the API by using TokenSNAAPPY generated before the revocation time. Alternatively, if the API exposing function has received a value (e.g., the token itself, or a value that distinguishes that token from other tokens) that can distinguish the token along with the token validity period when the revocation notification is received, the API exposing function can reject the request if the API invoker invokes the API by using the token containing that value. The API exposing function may store the TokenSNAAPPY requested to be revoked or the value(s) that can distinguish the token, up to the token validity period. The API exposing function can delete the value(s) associated with the revoked token after the validity period has expired. If an API invoker invokes an API using a token whose validity period has expired, the API exposing function can determine the validity of the token using only the token validity period. Therefore, if the token validity period has expired, the API exposing function can also delete the token's revocation information (this could be the token itself, a value that identifies the token, or its validity period).

FIG. 6 illustrates a flowchart of a process for a user to provide authorization information according to an embodiment of the present disclosure.

For the procedure shown in FIG. 6, the following processes can be performed in advance.
(A) The user can provide authorization information for the API invoker in advance to the storage managed by the operator.
(B) Upon receiving the authorization information from the user, the operator's storage can also store the validity period for the information (e.g., UE ID, API invoker ID, API information allowed for API invoker, etc.). In other words, when the validity period has expired, the authorization information may need to be received from the user again. The validity period may be determined depending on an operator's policy. The validity period for the authorization information may be similar to the validity period of the access token or refresh token.

With reference to FIG. 6, in step 601, the API invoker can perform an onboarding process with the CAPIF core function and then perform a mutual authentication process with the CAPIF core function.

In step 602, the API invoker can make an OAuth 2.0 token request to a CAPIF core function (CCF)/authorization function (AuF).

In step 603, the CCF/AuF can determine whether the API invoker's access token request is legitimate. If the API invoker requests a token needed to access information requiring user's authorization, step 604 and step 605 can be performed.

In step 604, the CCF/AuF can check in the Storage whether the user has authorized the API invoker to invoke the requested API.

In step 605, the Storage can notify user authorization information to the CCF/AuF.

In Step 606, if the CCF/AuF receives the user authorization information from the Storage in Step 605, the CCF/AuF can generate an OAuth token and deliver the token to the API invoker.

In step 607, the API invoker can establish a Transport Layer Security (TLS) connection with the API exposing function.

In Step 608, the API invoker can invoke the API to the API exposing function using the OAuth token received in Step 606.

In step 609, the API exposing function can verify the OAuth token received from the API invoker in step 608. The API exposing function can check before token verification whether the token has been revoked through the stored revocation information, or the API exposing function can check the revocation information after successful token verification.

In step 610, if the API exposing function succeeds in token verification in step 9, the API exposing function can make an API invocation response.

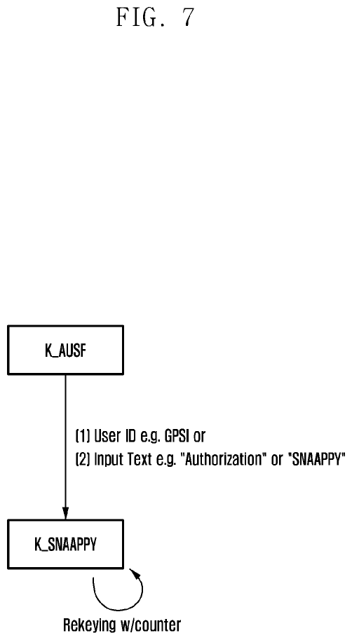

FIG. 7 illustrates an example of a process for calculating a key used for user authentication according to an embodiment of the present disclosure.

According to an embodiment of the disclosure, in the case of generating a key for checking user authentication in KAUSF, the UE or the AUSF can generate KSNAAPPY, which is a key for user authentication, by inputting KAUSF and the UE ID (e.g., GPSI or SUPI) or a constant (e.g., a string “authorization” or “SNAAPPY”) representing a certain input value into a key derivation function mutually agreed upon by the UE and the mobile communication system.

In addition, if the UE and the AUSF need to regenerate a key for user authentication to manage the validity period of KSNAAPPY, etc., the UE and the AUSF can define a variable constituting information of a counter for generating a separate KSNAAPPY or other input value so that a key different from the existing KSNAAPPY can be generated, and use this to generate KSNAAPPY. At this time, the variable that constitutes the counter or other input value may be mutually agreed upon in advance between the UE and the AUSF regarding its decision/input method, or its input value may be shared in advance between the UE and the AUSF.

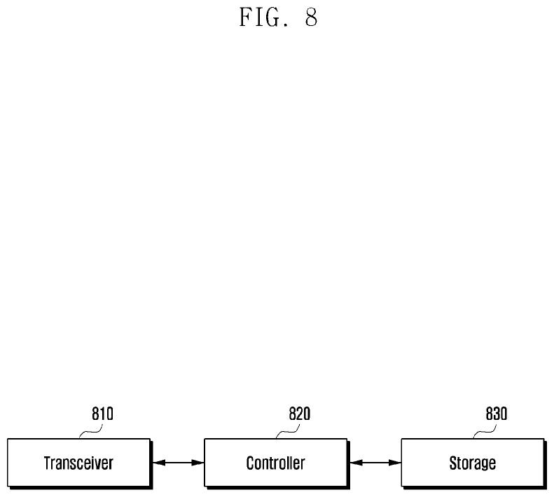

FIG. 8 illustrates a structure of a base station according to an embodiment of the present disclosure.

With reference to FIG. 8, the base station may include a transceiver 810, a controller 820, and a storage 830. The transceiver 810, the controller 820, and the storage 830 may operate according to the above-described communication method of the base station. Network devices may also correspond to the structure of a base station. The components of the base station are not limited to the above example. Alternatively, the base station may include more or fewer components than those described above. For example, the base station may include the transceiver 810 and the controller 820. In addition, the transceiver 810, the controller 820, and the storage 830 may also be implemented in the form of a single chip.

The transceiver 810 is a general term for a receiver and a transmitter of the base station and is capable of transmitting/receiving signals to/from a terminal, another base station, or other network devices. The transmitted and received signals may include control information and data. For example, the transceiver 810 may transmit system information to the terminal and may transmit a synchronization signal or a reference signal. To this end, the transceiver 810 may be composed of an RF transmitter that up-converts and amplifies the frequency of an outgoing signal, and an RF receiver that amplifies an incoming signal with low noise and down-converts the frequency. However, this is only an embodiment of the transceiver 810, and the components of the transceiver 810 are not limited to the RF transmitter and RF receiver. The transceiver 810 may include a wired or wireless transceiver and may include various components for transmitting and receiving signals. The transceiver 810 may receive a signal through a communication channel (e.g., a wireless channel) and output the received signal to the controller 820, and the transceiver may also transmit a signal output from the controller 820 through the communication channel. Additionally, the transceiver 810 may receive a communication signal and output the signal to a processor, and the transceiver may also transmit a signal output from the processor to a terminal, another base station, or any other entity through a wired or wireless network.

The storage 830 is capable of storing programs and data necessary for the operation of the base station. In addition, the storage 830 may store control information or data included in signals obtained from the base station. The storage 830 may be composed of a storage medium such as ROM, RAM, hard disk, CD-ROM, and DVD, or a combination of storage media. Additionally, the storage 830 may store at least one of information transmitted and received through the transceiver 810 and information generated through the controller 820.

The controller 820 may be defined as a circuit or application-specific integrated circuit or at least one processor. The processor may include a communication processor (CP) that performs control for communication, and an application processor (AP) that controls upper layers such as application programs. The controller 820 is capable of controlling the overall operation of the base station according to the embodiment provided in the disclosure. For example, the controller 820 may control signal flows between respective blocks to perform the operations in flowcharts described above.

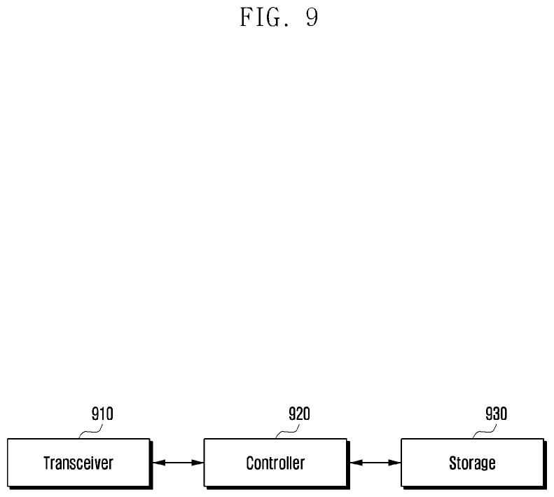

FIG. 9 illustrates a structure of a terminal according to an embodiment of the present disclosure.

With reference to FIG. 9, the terminal may include a transceiver 910, a controller 920, and a storage 930. The transceiver 910, the controller 920, and the storage 930 may operate according to the above-described communication method of the terminal. The components of the terminal are not limited to the above example. Alternatively, the terminal may include more or fewer components than those described above. For example, the terminal may include the transceiver 910 and the controller 920. In addition, the transceiver 910, the controller 920, and the storage 930 may also be implemented in the form of a single chip.

The transceiver 910 is a general term for a receiver and a transmitter of the terminal and is capable of transmitting/receiving signals to/from a base station, another terminal, or network entities. The transmitted and received signals may include control information and data. For example, the transceiver 910 may receive system information to the base station and may receive a synchronization signal or a reference signal. To this end, the transceiver 910 may be composed of an RF transmitter that up-converts and amplifies the frequency of an outgoing signal, and an RF receiver that amplifies an incoming signal with low noise and down-converts the frequency. However, this is only an embodiment of the transceiver 910, and the components of the transceiver 910 are not limited to the RF transmitter and RF receiver. The transceiver 910 may include a wired or wireless transceiver and may include various components for transmitting and receiving signals. The transceiver 910 may receive a signal through a wireless channel and output the received signal to the controller 920, and transceiver may also transmit a signal output from the controller 920 through the wireless channel. Additionally, the transceiver 910 may receive a communication signal and output signal to a processor, and transceiver may also transmit a signal output from the processor to network entities through a wired or wireless network.

The storage 930 is capable of storing programs and data necessary for the operation of the terminal. In addition, the storage 930 may store control information or data included in signals obtained from the terminal. The storage 930 may be composed of a storage medium such as ROM, RAM, hard disk, CD-ROM, and DVD, or a combination of storage media.

The controller 920 may be defined as a circuit or application-specific integrated circuit or at least one processor. The processor may include a communication processor (CP) that performs control for communication, and an application processor (AP) that controls upper layers such as application programs. The controller 920 is capable of controlling the overall operation of the terminal according to the embodiment provided in the disclosure. For example, the controller 920 may control signal flows between respective blocks to perform the operations in flowcharts described above.

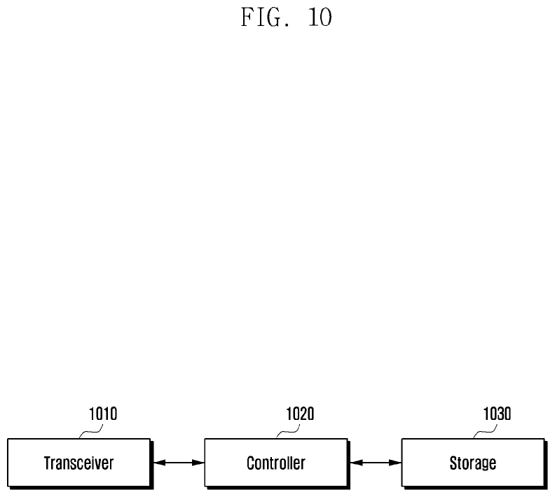

FIG. 10 illustrates a structure of a network entity (or network function) according to an embodiment of the present disclosure. The network entity (or network function) shown in FIG. 10 may represent exemplary structures of API invoker, API exposing function, authorization function, AAnF, AUSF, etc. previously described in FIGS. 1 to 7. The structure shown in FIG. 10 can be applied to any other network entities (or network functions) than the network entities (or network functions) described in FIGS. 1 to 7.

With reference to FIG. 10, the network entity (or network function) may include a transceiver 1010, a controller 1020, and a storage 1030. The transceiver 1010, the controller 1020, and the storage 1030 may operate according to the above-described communication method of the network entity (or network function). The components of the network entity (or network function) are not limited to the above example. Alternatively, the network entity (or network function) may include more or fewer components than those described above. For example, the network entity (or network function) may include the transceiver 1010 and the controller 1020. In addition, the transceiver 1010, the controller 1020, and the storage 1030 may also be implemented in the form of a single chip.

The transceiver 1010 is a general term for a receiver and a transmitter of the network entity (or network function) and is capable of transmitting/receiving signals to/from a base station, a terminal, or other network entities (or network functions). For example, the transceiver 1010 may transmit a signal for requesting user's authorization to the terminal through the base station, or may receive information for notifying approval or revocation of the user's authorization from the terminal through the base station. To this end, the transceiver 1010 may include a wired or wireless transceiver and may include various components for transmitting and receiving signals. The transceiver 1010 may receive a signal through a wireless channel or a wired backhaul network and output the received signal to the controller 1020, and transceiver may also transmit a signal output from the controller 1020 through the wireless channel. Additionally, the transceiver 1010 may receive a communication signal and output the signal to a processor, and the transceiver may also transmit a signal output from the processor to network entities through a wired or wireless network.

The storage 1030 is capable of storing programs and data necessary for the operation of the network entity (or network function). In addition, the storage 1030 may store control information or data included in signals obtained from the network entity (or network function). The storage 1030 may be composed of a storage medium such as ROM, RAM, hard disk, CD-ROM, and DVD, or a combination of storage media.

The controller 1020 may be defined as a circuit or application-specific integrated circuit or at least one processor. The processor may include a communication processor (CP) that performs control for communication, and an application processor (AP) that controls upper layers such as application programs. The controller 1020 is capable of controlling the overall operation of the network entity (or network function) according to the embodiment provided in the disclosure. For example, the controller 1020 may control signal flows between respective blocks to perform the operations in flowcharts described above.

The methods according to embodiments described herein may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program may include instructions that cause the electronic device to perform the methods according to various embodiments as defined by the appended claims and/or disclosed herein.

The programs (software modules or software) may be stored in non-volatile memories including a random access memory and a flash memory, a read only memory (ROM), an electrically erasable programmable read only memory (EEPROM), a magnetic disc storage device, a compact disc-ROM (CD-ROM), digital versatile discs (DVDs), or other type optical storage devices, or a magnetic cassette. Alternatively, any combination of some or all of them may form a memory in which the program is stored. Further, a plurality of such memories may be included in the electronic device.

In addition, the programs may be stored in an attachable storage device which may access the electronic device through communication networks such as the Internet, Intranet, local area network (LAN), wide LAN (WLAN), and storage area network (SAN) or a combination thereof. Such a storage device may access the electronic device via an external port. Further, a separate storage device on the communication network may access a portable electronic device.

In the above-described detailed embodiments, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

Various embodiments of the disclosure have been described. The above description of the disclosure is merely for the purpose of illustration, and is not intended to limit embodiments of the disclosure to the embodiments set forth herein. Those skilled in the art will appreciate that other specific modifications and changes may be easily made thereto without changing the technical idea or essential features of the disclosure. The scope of the disclosure should be determined not by the above description but by the appended claims, and all changes and modifications derived from the meaning and scope of the claims and equivalent concepts thereof shall be construed as falling within the scope of the disclosure.

Although the present disclosure has been described with various embodiments, various changes and modifications may be suggested to one skilled in the art. It is intended that the present disclosure encompass such changes and modifications as fall within the scope of the appended claims.

What is claimed is:

1. A method performed by an authorization function in a wireless communication system, the method comprising:
receiving, from an authentication server function (AUSF), an authentication key and an authentication key indicator;
receiving, from a user equipment (UE), at least one of the authentication key indicator, a first random value, or an indicator associated with an authentication operation;
generating a first authentication material based on the first random value and the authentication key;
transmitting, to the UE, the generated first authentication material and a second random value;
receiving, from the UE, a second authentication material, wherein the second authentication material is generated by the authentication key based on the authentication key indicator and the second authentication material after verifying the first authentication material using the first random value and the authentication key;
verifying the second authentication material using the authentication key;
authenticating a user after verifying the second authentication material; and
transmitting, to an application program interface (API) invoker, an authorization code,
wherein the UE redirected to the authorization function is authenticated by the API invoker.

2. The method of claim 1, further comprising:
receiving, from the API invoker, an authentication token request based on the authorization code; and
transmitting, to the API invoker, an authentication token based on the authorization code.

3. The method of claim 2, wherein the API invoker requests an API invoke including the authentication token to an API exposing function,
wherein the API exposing function determines whether the authentication token is verified or revoked, and
wherein, in case that the authentication token is verified and the authentication token is not revoked, the API exposing function transmits a response message to the API invoker.

4. The method of claim 2, further comprising:
transmitting, to the API invoker and an API exposing function, the authentication token and information related to a revocation of the authentication token.

5. The method of claim 4, wherein the information related to the revocation of the authentication token includes at least one of a resource owner, an identifier of the authentication token, and a token generation time.

6. A method performed by a user equipment (UE) in a wireless communication system, the method comprising:
receiving, from an authentication server function (AUSF), an indicator associated with an authentication operation;
generating an authentication key and an authentication key indicator based on the indicator associated with the authentication operation;
transmitting, to an authorization function, at least one of the authentication key indicator, a first random value, or the indicator associated with the authentication operation;
receiving, from the authorization function, a first authentication material and a second random value based on the first random value and the authentication key, wherein the first authentication material is generated based on the first random value and the authentication key;
verifying the first authentication material using the first random value and the authentication key;
generating a second authentication material using the authentication key based on the authentication key indicator and the second random value; and
transmitting, to the authorization function, the second authentication material,
wherein an authorization code is transmitted from the authorization function to an application program interface (API) invoker.

7. The method of claim 6, wherein an authentication token request is transmitted, based on the authorization code, from the API invoker to the authorization function; and
wherein an authentication token is transmitted, based on the authorization code, from the authorization function to the API invoker.

8. The method of claim 7, wherein the API invoker requests an API invoke including the authentication token to an API exposing function,
wherein the API exposing function determines whether the authentication token is verified or revoked, and
wherein, in case that the authentication token is verified and the authentication token is not revoked, the API exposing function transmits a response message to the API invoker.

9. The method of claim 7, wherein an authentication token and information related to a revocation of the authentication token, is transmitted from the authorization function to the API invoker and an API exposing function.

10. The method of claim 9, wherein the information related to the revocation of the authentication token includes at least one of a resource owner, an identifier of the authentication token, and a token generation time.

11. An authorization function in a wireless communication system, the authorization function comprising:
a transceiver; and
a controller operably connected to the transceiver, the controller configured to:
receive, from an authentication server function (AUSF), an authentication key and an authentication key indicator,
receive, from a user equipment (UE), at least one of the authentication key indicator, a first random value, or an indicator associated with an authentication operation,
generate a first authentication material based on the first random value and the authentication key,
transmit, to the UE, the generated first authentication material and a second random value,
receive, from the UE, a second authentication material, wherein the second authentication material is generated by the authentication key based on the authentication key indicator and the second authentication material after verifying the first authentication material using the first random value and the authentication key,
verify the second authentication material using the authentication key,
authenticate a user after verifying the second authentication material, and
transmit, to an application program interface (API) invoker, an authorization code,
wherein the UE redirected to the authorization function is authenticated by the API invoker.

12. The authorization function of claim 11, wherein the controller is further configured to:
receive, from the API invoker, an authentication token request based on the authorization code, and
transmit, to the API invoker, an authentication token based on the authorization code.

13. The authorization function of claim 12, wherein the API invoker requests an API invoke including the authentication token to an API exposing function,
wherein the API exposing function determines whether the authentication token is verified or revoked, and
wherein, in case that the authentication token is verified and the authentication token is not revoked, the API exposing function transmits a response message to the API invoker.

14. The authorization function of claim 12, wherein the controller is further configured to:
transmit, to the API invoker and an API exposing function, the authentication token and information related to a revocation of the authentication token.

15. The authorization function of claim 14, wherein the information related to the revocation of the authentication token includes at least one of a resource owner, an identifier of the authentication token, and a token generation time.

16. A user equipment (UE) in a wireless communication system, the UE comprising:
a transceiver; and
a controller operably connected to the transceiver, the controller configured to:
receive, from an authentication server function (AUSF), an indicator associated with an authentication operation,
generate an authentication key and an authentication key indicator based on the indicator associated with the authentication operation,
transmit, to an authorization function, at least one of the authentication key indicator, a first random value, or the indicator associated with the authentication operation,
receive, from the authorization function, a first authentication material and a second random value based on the first random value and the authentication key, wherein the first authentication material is generated based on the first random value and the authentication key,
verify the first authentication material using the first random value and the authentication key,
generate a second authentication material using the authentication key based on the authentication key indicator and the second random value, and
transmit, to the authorization function, the second authentication material,
wherein an authorization code is transmitted from the authorization function to an application program interface (API) invoker.

17. The UE of claim 16, wherein an authentication token request is transmitted, based on the authorization code, from the API invoker to the authorization function; and
wherein an authentication token is transmitted, based on the authorization code, from the authorization function to the API invoker.

18. The UE of claim 17, wherein the API invoker requests an API invoke including the authentication token to an API exposing function,
wherein the API exposing function determines whether the authentication token is verified or revoked, and
wherein, in case that the authentication token is verified and the authentication token is not revoked, the API exposing function transmits a response message to the API invoker.

19. The UE of claim 17, wherein an authentication token and information related to a revocation of the authentication token, is transmitted from the authorization function to the API invoker and an API exposing function.

20. The UE of claim 19, wherein the information related to the revocation of the authentication token includes at least one of a resource owner, an identifier of the authentication token, and a token generation time.
